(19) United States
(12) Patent Application Publication
(10) Pub. No.: US 2025/0061785 A1
(43) Pub. Date: Feb. 20, 2025

(54) METHOD AND A COMMUNICATION DEVICE FOR DETECTING ANOTHER COMMUNICATION DEVICE

(71) Applicant: Telefonaktiebolaget LM Ericsson (publ), Stockholm (SE)

(72) Inventors: Peter ÖKVIST, Luleå (SE); Tommy ARNGREN, Södra Sunderbyn (SE)

(21) Appl. No.: 18/722,666

(22) PCT Filed: Dec. 23, 2021
(86) PCT No.: PCT/EP2021/087529

§ 371 Date: Jun. 21, 2024

(51) Int. Cl. G08B 5/36

(52) U.S. Cl. CPC G08B 5/36

(57) ABSTRACT

A method at a communication device for engaging in a communication device detection process includes providing, to a detection function, a request for at least one of the first communication device and a second communication device to attempt to detect the other communication device during a detection phase; receiving, from the detection function, details on an emitted light pattern to be applied by the first communication device during the detection phase, and participate in the detection phase, based on at least parts of the received details on an emitted light pattern.

### TECHNICAL FIELD

The present disclosure refers to methods at a communication device, participating in an attempt to detect another communication device, communication devices adapted for executing the mentioned methods, and a detection function, adapted to provide detecting functionality, as described herein, to the mentioned communication devices.

### BACKGROUND

One of the hazards of going to big events, such as e.g. concerts and festivals, is the possibility of losing contact with friends and family in a massive crowd. There are different solutions available that can address this issue, such as e.g. the “LookFor”-app that basically turns the screen of your iPhone or Android device into a blinking-colored light source, so that you can hold it up above your head, thereby helping your friends to spot you more easily. You can choose from one of six colors, and as long as you and your friends know one another's color choices, it should be fairly easy to spot each other in reasonably sized crowds, as long as no other user is using the same approach and the same color in your vicinity.

Other ways of trying to detect a lost friend in a crowd may include calling, texting or holding up a phone with the flashlight feature enabled, or using detection-based services, such as e.g. the Global Positioning System (GPS). However, during big events it is often too noisy for people to hear and notice when they're being called or texted, and GPS might not be available or may be too inaccurate.

Another example is Uber Spotlight that transforms your phone screen into a glowing spotlight that guides a driver to your present location. The solutions described above are both based on use of flickering-light for detection by the human eyes. However, there also exist solutions that make use of visible light for bidirectional communication between regular smartphones by applying small LEDs integrated in consumer electronics. The paper “Decoding Methods in LED-to-Smartphone Bidirectional Communication for the IoT” of Global LiFi Congress, February 2018, by Alexis Ducue et al. describes an efficient image processing algorithm for accurately detecting LEDs and for decoding their signal in real time. In addition to enabling flash-to-LED communication on non-rooted smartphones, an encoding and decoding method is described that cope with the inaccurate flashlight clock rate.

Despite being informed that a certain person is detected at a crowded venue, it may be challenging to also manage to actually find this person and to meet face-to-face. For example, at a concert, having 1000+ people at a pitch or field, you may know that the person is there, but how to navigate to meet up with that person is a completely different thing. Typically, you must appoint with the person to meet at some easy to find nearby physical object, such as e.g. a certain flagpole, corner of mixer spot, etc. Putting up one hand in the sea of other 1000 hands is also prone to fail, or at least require some extensive search-for mission by at least one of the parties.

Solutions of today that uses color and/or flickering-light to be discovered by the human eye are disadvantageous in cases where a large number of light sources are used at the same time or where users are experiencing a reduced line of sight due to a large crowd.

### SUMMARY

It is an object of the present disclosure to address the issues mentioned above.

According to one aspect, a method at a first communication device for engaging in a communication device detection process is suggested, where the method comprise providing a request for at least one of the first communication device and a second communication device to a detection function, requesting to attempt to detect the other communication device during a detection phase; to receive details on an emitted light pattern to be applied by the first communication device during the detection phase, from the detection function, and to participate in the detection phase, based on at least parts of the received details on an emitted light pattern.

According to another aspect, a method at a second communication device for engaging in communication device detection process is suggested, where the method comprise: receiving an indication that a first communication device has requested at least one of a first communication device and the second communication device to attempt to detect the other communication device during a detection phase, from a detection function; receiving details on an emitted light pattern to be applied by the second communication device during the detection phase from the detection function, upon having provided an acceptance of the request to the detection function, and participating in the detection phase, by applying at least parts of the received details on the emitted light pattern.

According to yet another aspect, a method, at a detection function, for providing a communication device detection procedure to at least two communication devices is suggested, where the method comprise: receiving a request from the first communication device, requesting one of a first communication device and a second communication device to attempt to detect the other communication device; determining details on a light pattern to be applied by the first communication device and the second communication device during a detection phase, upon having received an acceptance of the request from one of the communication devices, and providing the determined details on the light pattern to the first and the second communication device.

According to another aspect, a first communication device for engaging in a communication device detection process is suggested, where the first communication device is being configured to: provide a request for at least one of the first communication device and a second communication device to attempt to detect the other communication device during a detection phase, to a detection function; receive details on an emitted light pattern to be applied by the first communication device during the detection phase, from the detection function, and participate in the detection phase, based on at least parts of the received details on an emitted light pattern.

According to another aspect, a second communication device for engaging in a communication device detection process is suggested, where the second communication device is configured to: receive an indication that a first communication device has requested at least one of a first communication device and the second communication device to attempt to detect the other communication device during a detection phase from a detection function; receive details on an emitted light pattern to be applied by the second communication device during the detection phase, from the detection function, upon having provided an acceptance of the request to the detection function, and participate in the detection phase, by applying at least parts of the received details on the emitted light pattern.

According to another aspect a detection function, for providing a communication device detection procedure to at least two communication devices is suggested, where the detection function is configured to: receive a request from the first communication device, requesting one of a first communication device and a second communication device to attempt to detect the other communication device; determine details on a light pattern to be applied by the first communication device and the second communication device during a detection phase, upon having received an acceptance of the request from one of the communication devices, and provide the determined details on the light pattern to the first and the second communication device.

### BRIEF DESCRIPTION OF DRAWINGS

Embodiments will now be described in more detail in relation to the accompanying drawings, in which:

FIGS. 1a and 1b are illustrations of a system, capable of providing a communication device detection function, based on an emitted pattern.

FIG. 2a is a signalling scheme, illustrating two communication devices, engaged in a communication device detection procedure provided by a detection function, according to one embodiment.

FIG. 2b is another signalling scheme, illustrating two communication devices engaged in a communication device detection procedure provided by a detection function, according to another embodiment.

FIG. 3a is a flow chart, illustrating a method at a communication device, for engaging in a communication device detection procedure, according to one embodiment.

FIG. 3b is another flow chart, illustrating a method at a communication device, for engaging in a communication device detection procedure, according to another embodiment.

FIG. 3c is yet another flow chart, illustrating a method at a communication device, for engaging in a communication device detection procedure, according to yet another embodiment.

FIG. 3d is another flow chart, illustrating a method at a communication device, for engaging in a communication device detection procedure, according to yet another embodiment.

FIG. 4 is a flow chart, illustrating a method at a detection function, for providing a detection procedure to at least two communication devices.

FIG. 5a is a block scheme, illustrating a communication device, capable of initiating a communication device detection procedure according to one embodiment.

FIG. 5b is a block scheme, illustrating a communication device, capable of initiating a communication device detection procedure according to another embodiment.

FIG. 6a is a block scheme, illustrating a communication device, capable of participating in a communication device detection procedure according to one embodiment.

FIG. 6b is a block scheme, illustrating a communication device, capable of participating in a communication device detection procedure according to another embodiment.

FIG. 7a is a block scheme, illustrating a detection function, capable of providing a communication device detection procedure to at least two communication devices according to one embodiment.

FIG. 7b is a block scheme, illustrating a detection function, capable of providing a communication device detection procedure to at least two communication devices according to another embodiment.

### DETAILED DESCRIPTION

In order to, at least to some extent, remedy the problems mentioned above, a new technical solution is suggested which enables at least two communication devices to participate in a new communication device detection procedure, from herein after referred to as a detection procedure, where a first communication device search for a second communication device by searching for a specific, determined pattern, which is emitted by the second communication device, where the pattern is emitted according to specific details, distinguishing the determined pattern from other emitted patterns, used in other communication device detection procedures. The mentioned details also comprise instructions to the users of the communication devices on how to perform the detection procedure in an efficient way, where at least one of the communication devices will be instructed by the detection function how to emit the specific pattern, whereas the other one or more communication devices involved in the procedure will be instructed by the detection function on how to search for the emitted pattern.

The detection procedure mentioned above is achieved by one of the communication devices requesting the mentioned detection function, which may reside centrally, e.g. at a central server, in a cloud solution, or in any other type of network entity, to provide or offer a communication device detection procedure to the requesting communication device and at least one other communication device, in situations where the two or more communication devices have radio access to a communication network, such as via e.g. a 4G or 5G network, in case the detection function forms part of the communication network, or, where the communication devices instead have direct access between each other, e.g. in case the communication devices do not have radio access to any communication network, but are capable of communicating with each other by applying device-to-device (D2D), communication, according to any available D2D standard, such D2D communication may be applied instead. Alternatively, the detection function may be distributed, such that e.g. the main functionality is arranged within one of the communication devices, whereas conventional positioning functionality is arranged centrally.

The communication device may be any type of handheld communication device which have any type of known radio or wireless communication capability, such as e.g. a cellular communication device, lap top, pad or any other type of hand held device which is either capable of acting as a pattern searching and detecting device, or as a pattern emitting device, as described herein. It is here to be understood that the searching functionality of one communication device need to be able to identify the direction to another communication device, which has emitted a distinguishable pattern, thereby also detecting the pattern emitting communication device, whereas the one or more pattern emitting sources of a communication device to be detected need to be capable of emitting a pattern that can be detected and identified from a distance, although the searching and pattern emitted devices are located remotely from each other, where the distance can be up to at least 100 m, depending on visibility and time of day. By way of example, searching in a dark environment, will typically provide improved conditions for a successful detecting process.

The suggested method is particularly useful in situations where conventional positioning or location procedures are insufficient for the users to detect each other, e.g. due to being in a big crowd or in a dark place, where it can be difficult, or even impossible to detect each other also when the users are relatively close to each other, since e.g. the visibility may prohibit direct visible contact. In such a situation, use of the suggested method will enable the users to get automated guidance, allowing the users to, after a successful detection, gradually approach each other without having to loose visible contact during the procedure.

The expression detecting is, in the present context, to be construed as identifying, a specific communication device, after having searched for a specific emitted pattern, e.g. by scanning for an emitted light pattern, by applying a scanning function, typically provided by one or more cameras, capable of scanning for a specific light emission sequence or pattern, or, alternatively, by searching for emitted sound by applying a microphone or any other sound sensing device, or by applying emitted sound and light in a combination.

Identifying here means that an emitted pattern, determined by a detection function, that has been detected by a searching communication device is compared to the pattern determined by the detection function, at the searching communication device, as being a pattern allocated for the communication devices involved in the detection process. The mentioned detection function is achieved without requiring any user interaction other than following given instructions on e.g. execution of the actual sweeping, searching or a scanning movement of the communication device until detection of a desired communication device, is determined. Such instructions may e.g. instruct the user to start to search widely in a certain direction, followed by one or more narrowed down search. Once a successful detection is a fact, in the sense that one of the communication devices has detected the other communication devices, the users of the two communication devices, may take over from the automated functionality and use their devices and the emitting and searching functionality when approaching each other, until they can establish physical eye contact. Alternatively, or in combination, the user may be provided with guidance on the detected direction, which may be presented to the user via the user interface of the searching communication device, e.g. by presenting relevant information in one or more of written, graphical or audible form, such as e.g. the written message “continue in this direction” when moving in the direction of the detected communication device.

According to another embodiment, a user may instead be provided with graphical guidance, guiding the user to physically reach the detected communication device. Such graphical guidance may e.g. include arrows pointing in the direction in which the user should move. Guidance may alternatively, or in combination, be arranged such that the shown guidance appear in different colours, depending on the correctness of the direction of movement, such that e.g. guidance is shown in green when the direction is relatively correct, whereas the colour is shifting, first to yellow then to orange and finally to red if the user is drifting out of the desired moving direction. The location function described above may rely its guidance on the already applied emitting/searching procedure, on any conventional positioning functionality, such as e.g. GPS, or on a combination of both techniques.

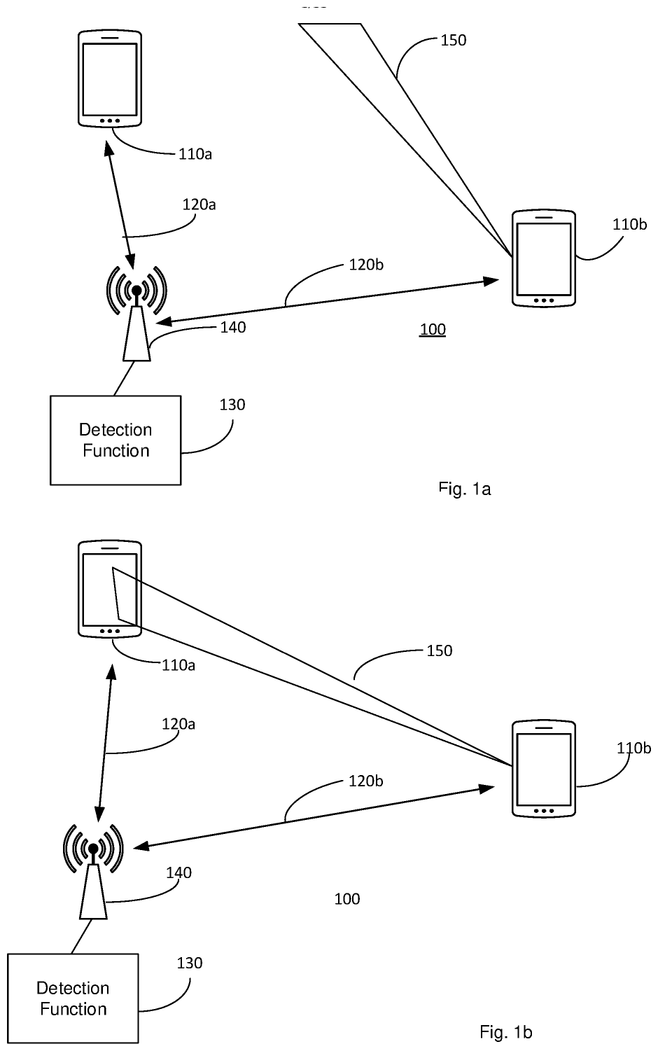

A scenario where two communication devices are capable of detecting each other according to a procedure as presented herein, will now be described with reference to FIGS. 1a and 1b, where, in FIG. 1a, a user of a first communication device 110a wants to enable one of the two communication devices 110a, 110b to detect the other. The first communication device 110a therefore sets up a connection 120a with a detection function 130, here presented as a separate function, provided in a network node, via an access node 140 of a communication network 100. Alternatively, the detection function 130 is a local function, available at the first communication device 110a or the second communication device 110b, which is first activated, if not already active, and then applied, accordingly.

The detection function 130 notifies the second communication device 110b via another connection 120b, provided by the communication network 100. Alternatively, the detection function resides at the second communication device 110b. In the latter situation, this notification can be executed internally within the second communication device 110b. Once a communication has been set up with the two communication devices 110a, 110b, the detection function 130 will be able to determine details on a search pattern to be applied by both communication devices 110a, 110b, including instructions for the users of the communication devices on how to handle their respective communication device during a detection phase, i.e. a determined time interval during which a detection attempt, according to the described detection procedure will take place. Typically, the second communication device 110b, will first have accepted the request to the detection function 130.

In the given example, the first communication device is the device that is initiating the detection attempt. In a typical scenario, it is the user of the first communication device that is requesting to search for the second communication device, but alternatively, the user of the first communication device may request the second communication device to instead search for the first communication device, e.g. due to that the environment seems more promising for applying that approach.

The detection function 130, which may handle a large number of detection requests simultaneously, may, according to one embodiment, consider already ongoing detection procedures when determining details for the mentioned detection procedure, thereby minimizing the risk of interference between different detection procedures, which may be ongoing in the same environment. Such determination may be based on a random selection of details to be applied by the involved communication devices.

Alternatively, a code may, according to another embodiment, be selected from a large number of already available, and possibly even user dedicated, reusable codes, thereby minimizing the risk of two detection processes using the same code at the same time. In its simplest scenario, such information may be limited to a pattern or sequence, based on a code specifically dedicated to a specific user and/or communication device to be used by that communication device whenever requiring to detect another communication device, as suggested and described herein. Thereby, a specific communication device may consistently apply a specific pattern or sequence for all detecting procedures, or the same pattern or sequence may be used when trying to detect a certain communication device or a certain group or category of communication devices.

According to another alternative, the communication devices may initially apply a specific pattern or sequence, but may apply another strategy if a detecting procedure, based on a fixed pattern or sequence, fails.

The determined details on the pattern may be scheduled e.g. as a flickering light sequence, applied where one or more parameters, such as e.g. tone, the flickering frequency, the intensity or the direction of the emitted pattern, can be determined and applied in a controlled way. In addition, or alternatively, the pattern may comprise various details additional on one or more of specific sequences, intervals, and frequencies.

From the perspective of the emission of the pattern, the mentioned details may include one or more details, specifying an emitting procedure to one or more pattern emitting communication devices to be applied during a detection phase or between two detection phases, in case a detection procedure need to be repeated. More specifically such details may comprise more or less detailed instructions on how an emitted pattern shall be emitted, in a flickering or a more steady matter, and may include one or more of the exemplifications mentioned below.

Different types of patterns may be emitted and searched for. According to one embodiment, the emitted patter is a light pattern, emitted by a communication device, using one or more light emitting sources, such as e.g. one or more LEDs, whereas the searching communication device is using one or more pattern sensing devices or light detectors, such as e.g. one or more cameras, for detecting the relevant emitted light pattern.

According to another embodiment, the emitted pattern is instead a sound pattern which has been emitted by a communication device, using one or more sound emitting sources, such as e.g. a frequency generator, whereas the communication device which is searched for is using one or more sound detectors, such as e.g. one or more microphones, for detecting the relevant emitted sound pattern.

According to yet another embodiment, a combination of both mentioned approaches is used.

A detection phase is, in the present context, to be defined as a phase during which one or more communication devices are emitting light for the purpose of being detected by one or more other communication device, and may be defined e.g. as one or more fixed time intervals, or as one or more dynamic phases, where e.g. a time interval can be dynamically determined, based on e.g. a number of already executed attempts to emit a pattern, which have failed in a detection attempt executed by the emitting communication device. If a detection phase fails to detect a communication device, another detection phase may be initiated, where the emission pattern and searching procedures are executed either by repeating the process by applying the same details or by executing a new detection phase by applying different details, thereby going for a new searching attempt.

The mentioned details may comprise an indication on at least one direction in which to arrange the at least one emitting pattern source during a detection phase, where such details are typically provided in a sequence of directions, which are to be applied in a certain order, e.g. depending on previous failed attempts to detect a communication device.

The details may also comprise indications of at least one pace in which to move the at least one emitting pattern source during a detection phase, where the applied pace may be static or dynamic, or a combination of both.

A timing to be applied during movement of the at least one emitting light source may be provided as other details, such that e.g. an emitting communication device is moved by the user at a certain time instance or a certain time interval.

The light strength to be applied, in case of using light emission, by at least one emitting light source may also be specified in the details, depending e.g. on the visibility in the environment to be searched, or due to the codes applied during the light emission.

The details may also specify at least one frequency to be applied by one or more emitting pattern sources, e.g. as a flickering frequency, where a frequency may be static or dynamic.

The details may also specify at least one sequence in which to combine emitting pattern sources, in case a plurality of pattern sources are to be applied.

The details may also specify at least one sequence in which to move the at least one emitting pattern source.

With respect to the searching of a light source pattern, it may be executed by applying one or more cameras of the first communication device 110a, which may e.g. include one or more of a back-end camera, a front-end camera or a combination of both, which are capable of scanning for the relevant light pattern. Alternatively, or in addition, a separate camera, connectable to the first communication device 110a may be applied.

The details with respect to the searching of a communication device, trying to detect and locate another communication device, may also refer to one specific location phase or different details may be provided, intended for different location phases, in case more than one location phase will be needed, due to failure to locate a communication device. These details may specify various parameters and/or rules which allows an ongoing pattern emission procedure to be allocated or synchronized with an associated searching procedure. More specifically these details may comprise one specific detail in the form of e.g. parameters and instructions or a combination of details, specifying the searching process so that they are coordinated with the details provided to the emitting communication device, where some examples of details which may be applied alone or in a combination are listed below.

Details could specify at least one direction in which to arrange the at least one camera, during searching for a light pattern, or at least one microphone during searching for a sound pattern.

Details may indicate at least one orientation in which to arrange the at least one camera during searching.

Other details may specify at least one sequence in which to sweep at least one camera during searching.

Yet other details may specify how to activate at least one camera during searching.

Other details may specify when in time to initiate searching. Such timing may be determined according to a code, selected for the relevant location process.

Although only searching for emitted light is considered in the example above, it is to be understood that, alternatively, a microphone or any other type of sound sensing or searching device may be applied, if sound is emitted instead of light.

Once relevant, unique details have been determined by the detection function, both with respect to the pattern emission and the searching, the respective, coordinated details are provided to both communication devices 110a, 110b, via the respective connection 120a, 120b, thereby informing the second communication device 110b on how to schedule a pattern emission 150 via at least one light source, available to the second communication device 120b, whereas the first communication device 110a is informed on how to search for the one or more pattern emitting sources, by directing a pattern emission 150 in a specific direction.

The one or more pattern sources to be applied by a communication device may comprise one or more pattern sources, integrated with the communication device, one or more separate pattern sources, connectable to the communication device, or a combination of both, and may, in case of light emission, be arranged as one or more of a flashlight, an infra-red (IR) light, a lidar, a display light of the display of the second communication device 110b or one or more Light-emitting diodes (LED) of the second communication device 110b, whereas, in case of sound emission, the one or more sound sources may be e.g. a sonar.

The mentioned pattern to de determined and used may either be determined as a pattern being emitted in a sequence or code which is uniquely distinguished from any other sequence or code applied by any other communication device which the detecting function is aware of, or it can be selected on a more or less random basis, typically from a large amount of possible options, thereby minimizing the risk of two detecting procedures using the same sequence or pattern at the same time. Assuming that a sufficiently large set of e.g. pseudo-random number codes are available to the detection function, for allocation to the communication devices, the detection function may select one code to use from e.g. a pool of 2\hat{ }N−1 where the probability of randomly selected a code already in use goes close to zero already at rather modest numbers of N.

As will be described below, more than one communication device can participate in the emission of a pattern, thereby assisting a pattern emitting communication device, in order to enhance the chance of fast detection of a communication device. Thereby, a plurality of communication devices, located relatively close to each other may emit a pattern in collaboration, according to a specific coordinated scheme. In a corresponding way, a plurality of communication devices may collaboratively search for a communication device, thereby increasing the chance of detection.

In FIG. 1a, a procedure, such as the one described above, has recently started, where a pattern is emitted 150, in a sweeping manner, according to the details determined by the detection function 130, whereas in FIG. 1b, the second communication device 110b, searched for by the first communication device 110a has been detected, thanks to that the emitted pattern 150, being emitted according to the determined scheme, known to both communication devices 110a, 110b, has been recognized during the searching process executed by the first communication device 110a, as matching with the determined scheme.

The mentioned pattern 150 may be emitted by applying one or more emitting pattern sources of the second communication device 110b, or one or more emitting pattern sources, available to the second communication device 110b, e.g. by being connected to the second communication device 110b, or a combination of both. In order to provide for a unique pattern to be applied, with a minimized risk of disturbance between two detection procedures, unique codes are preferably used during the pattern emission. There are basically two types of sequence codes available for this purpose, namely truly orthogonal or pseudo-random sequences.

Pseudo-random number codes (pseudo-noise or PN code) can be generated very easily. These codes will sum to zero over a period of time. Although the sequence is deterministic because of the limited length of e.g. a linear shift register used to generate the sequence, they provide a PN code, similar to those that can be used within a CDMA system, to provide a required spreading code. Such codes are used within many systems as there is a very large number that can be used. One aspect of PN codes is that if the same versions of the PN code are time shifted, they will become almost orthogonal, and can be used as virtually orthogonal codes within a CDMA system.

The other version of codes is referred to as so called truly orthogonal codes, wherein two codes are considered orthogonal if, when they are multiplied together, the result added over a period of time sum to zero. For example, a code 1 −1 −1 1 and another code 1 −1 1 −1 gives the sum zero (1 1 −1 −1) when multiplied together. An example of an orthogonal code set is Walsh codes, used within the CDMA2000 system.

Similar concepts are also considered in the context of light when provided in optical fiber communications, e.g. in the form of optical orthogonal codes, where study of optical orthogonal codes has been motivated by an application in a code-division multiple-access fiber optic channel. Use of optical orthogonal codes enables a large number of asynchronous users to transmit information efficiently and reliably over a shared-light spectrum channel.

Any of the coding principles mentioned above may be applied by the detection function, but also simpler schemes may be applied, especially in situations where none or very few other detection procedures are ongoing in the relevant environment.

Light or sound may be emitted from one communication device in “raw format”, describing an on/off pattern, such as e.g. [1 1 1 1 1 0 0 0 0 1 0 0 0 0 1 1 1 1 1 0 0 0 . . . ], where “1” is denoted “on” and “0” is denoted off, or vice versa, where a number “1/0” may be associated also with a time duration of the mentioned pattern on/off rendering. Such a sequence can then be rendered in another communication device, searching for the emitted pattern.

Use of pseudo-random codes or random selection codes, i.e. use of sequences that may (with low but non-zero probability) be detected/selected/used by someone else may be subject to type of communication and user context. A covert-like action where first and second users may not desire to disclose a pattern sequence, being used for identification deterministic means to render codes in combination with a server-selected code detection, may be considered and also out-of-band code selection principles may apply.

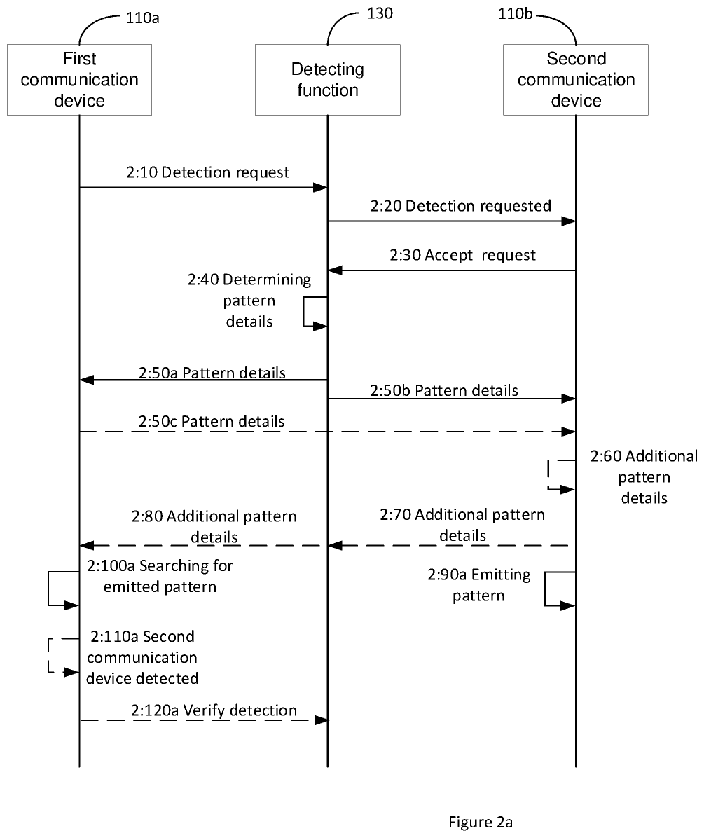

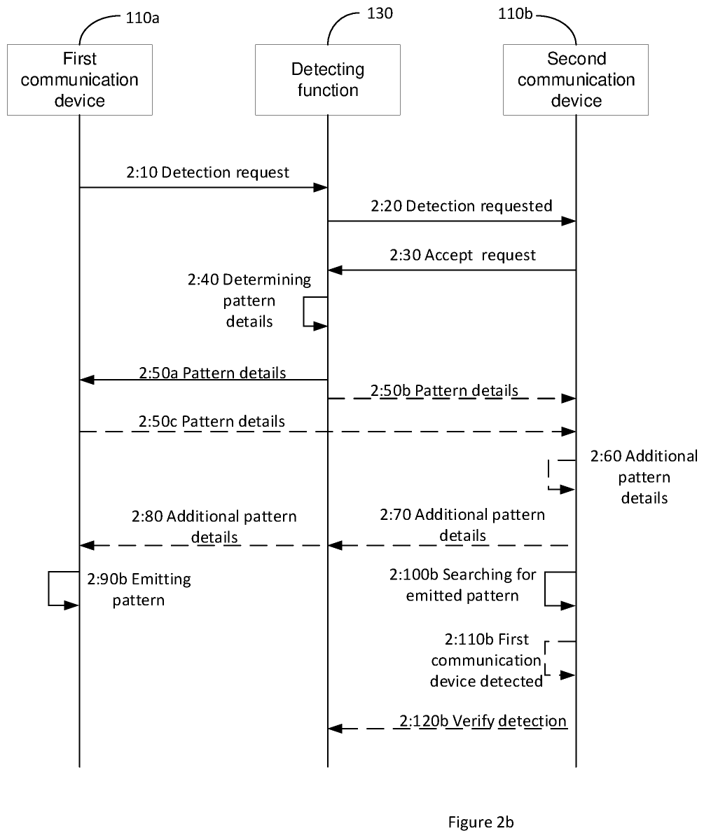

A procedure for detecting a communication device will now be described in further detail with reference to the signaling scheme of FIG. 2a, depicting a first communication device 110a, striving for detecting a second communication device 110b, with the assistance of a detection function 130. As a prerequisite, the communication devices 110a, 110b to be engaged in a detection procedure, both have access to the mentioned detection function, e.g. via an app or a web browser.

In a first step of FIG. 2a, a first communication device 110a, wanting a detection procedure to be initiated, transmits a detection request 2:10 to the detection function 130. Such a request may, in its simplest form identify the second communication device 110b, e.g. by its telephone number. The request may also comprise the telephone number or any other identity, such as e.g. the name of the user of the requesting, first communication device 110a, for information to the second communication device 110b. In addition, the request may also comprise further information from the user of the first communication device 110a, to the user of the second communication device 110b, such as e.g. the purpose with the request. A detection request notification is then provided from the detection function 130 to the second communication device 110b, making the second communication device 110b aware of the request, as indicated with step 2:20. A notification to the second communication device 110b, may e.g. be configured as:
“+4607123456 lost” or
“meet with +4607123456?”
or more detailed such as e.g.
“+4607123456 has requested to search for you. If you accept, information on how to execute a search will be provided to you soon”.

The given examples suggest that it is the user of the first communication device 110a that wants to detect the second communication device 110b, but, alternatively, the user of the first communication device 110a may initiate a detection procedure, but instead of requesting to be able to search for the second communication device 110b, it may request the user of the second communication device 110b to execute a search for the first communication device 110a.

The second communication device 110b, may respond to the request by accepting the request in an acceptance 2:30, to the detection function 130, or reject the request (not shown). Although not shown in the figure, the signaling may also include a direct signaling between the two communication devices 110a, 110b, e.g. for exchange of data between the devices, as well as to allow for a dialogue and negotiation between the users of the two devices 110a, 110b. Such direct, additional signalling may e.g. be applied if the users of the two communication devices 110a, 110b negotiate with each other, so as to determine which device to be the emitting on and which device to be the searching one, according to the alternative embodiment, suggested above.

Furthermore, an acceptance or rejection of the request may also be provided from the detection function 130, to the first communication device 110a, and/or directly from the second communication device 110b, once the request 2:20 has been received by the second communication device 110b.

In response to receiving an acceptance of the request, the detection function 130 will determine relevant pattern details, to be applied by the involved communication devices 110a, 110b, as indicated with step 2:40, where such details may, as already mentioned, include various details for providing a sufficiently unique emitted pattern scheme, and a corresponding searching scheme, as well as instructions for the users of the respective communication devices 110a, 110b, on how to execute the detection procedure, i.e. how to direct and move the respective communication device 110a, 110b, in order to enhance fast detection.

When determining the mentioned details, the detecting function 130 may consider different available data, such as e.g. other ongoing or planned detection procedures, as well as other communication devices, which can participate in the initiated detection procedure. Once the relevant details have been determined, they are provided to the respective communication device 110a, 110b, wherein the first communication device 110a is provided with details relevant for that device in step 2:50a, which here comprise details on how to search for the pattern emitted by the second communication device 110b, whereas the second communication device 110b is provided with details relevant for that device on how to emit the determined pattern in another step 2:50b. Although step 2:50a is executed prior to step 2:50b in FIG. 2a it is to be understood that these steps can be executed in any order, as long as both communication devices 110a, 110b are provided with the respective relevant details for being able to execute the requested detection procedure, before an actual controlled pattern emission is initiated by the second communication device 110b in step 2:90a, and a controlled pattern searching is initiated by the first communication device in step 2:100a.

Pattern details may also be provided from the first to the second communication device, as indicated with optional step 2:50c, which may be executed in addition to step 2:50b, or as an alternative to step 2:50b, where parts of the details needed for the second communication device 110b, may be provided to that communication device in that step. By way of example, step 2:50c may comprise a message to the user of the second communication device, saying e.g. “+4612345 will now start flashing light according to the enclosed pattern” or “I have lost you, please start flashing with your phone, using the enclosed pattern so that +4612345 can find you”.

As indicated in FIG. 2a, the initiation of the emission and the searching may alternatively be preceded by optional step 2:60, where the second communication device 110b, may select pattern details provided as selectable options to the second communication device 110b from the detection function 130 in step 2:50b or in a separate, not shown, step. If such selectable details are selected in optional step 2:60, the detection function 130 is informed of these details in optional step 2:70, and the first communication device 110a may be informed of these details in another optional step 2:80, executed before pattern emission is initiated. Although not shown, the first communication device 110a may in a corresponding way be able to choose selectable options, where the selected options are then notified to the detection function 130 and the second communication device 110b.

According to another, not shown option, the detection phase may also comprise a procedure for capabilities exchange between the two devices 110a, 110b, wherein the devices 110a, 110b are exchanging capabilities, which may be relevant for the detection procedure, where such a capabilities exchange may be executed by way of applying D2D communication, without involving the detection function 130, or such an exchange may be executed via the detection function 130. The former scenario provides for more free selections of preferred strategy by the devices 110a, 110b, whereas in the latter scenario, the detection function 130 may coordinate and control a preferred strategy. By way of examples, the capabilities of a camera to be applied for scanning of emitted light by the first communication device may be decisive of which light emitting strategy to be applied by the second communication device, whereas light emitting capabilities of the second communication device may be decisive of a chosen strategy in a similar manner. In another embodiment, capabilities of both devices 110a, 110b, may be considered when making a trade-off as to which strategy to apply. According to yet another embodiment, capabilities of the two communication devices 110a, 110b may be decisive of which communication device that is to emit a pattern and which device that is to search for the emitted pattern.

The pattern emission and searching procedures may continue until it is determined, at the first communication device 110a, that the second communication device 110b has been detected, as indicated with optional step 2:110a, wherein the first communication device 110a, recognizes that a detected pattern corresponds to a specific, wanted pattern, and notifies the detection function 130 that the second communication device 110b has been detected, in a subsequent optional step 2:120a, and, thus, that the ongoing detection procedure can be terminated by the detection function 130 and involved communication devices 110a, 110b. Although not shown, a corresponding verification may be provided also to the second communication device 110b, either from the location function 130, or from the first communication device 110a. As a, not shown, alternative to the suggested automated determination of detection, the user of the respective communication device may indicate to the user of the other communication device, and the detection function 130, that the other device has been detected.

FIG. 2b is illustrating another signaling scheme according to another embodiment, where each of steps 2:10-2:80 is identical to the corresponding steps of FIG. 2a, whereas remaining steps differ in such a way that the emitting device and the searching device has been switched. More specifically, the first communication device 110a is starting to emit a pattern in step 2:90b, based on relevant pattern details, received by the first communication device 110a. In a subsequent step 2:100b, the second communication device 100b, is starting to search for the emitted pattern, based on relevant pattern details, received by the second communication device 110b. When the second communication device 110b has detected the emitted pattern, and thus, also the first communication device 110a, as indicated with optional step 2:110b, it may terminate the detection phase and the detection procedure, or it may maintain the detection process, until the users of the two communication devices 110a, 110b, have also connected physically, e.g. by assisting the users by applying visible light. As indicated with an optional step 2:120b, the second communication device 110b can provide signaling to the detection function 130, indicating that the first communication device 110a has been detected. Such a signaling may e.g. be initiated manually by the user of the second communication device 110b when the user is of the opinion that the detection process can be terminated.

As already mentioned, a plurality of additional communication devices may also be involved in the mentioned detection process, thereby enabling to speed up the detection process. In such a scenario further considerations, involving also these additional communication devices, will be taken in step 2:40 of FIG. 2a or 2b and the relevant further communication devices will be notified of the determined pattern details in further steps, corresponding to steps 2:50a and 2:50b of FIG. 2a or 2b. Corresponding subsequent steps of FIG. 2a or 2b may then be executed also for the additional communication devices, which may participate in either the suggested light emitting procedure or the scanning procedure, until the relevant communication device 110b is considered to have been detected.

Regarding possible cooperation between a plurality of communication devices, a number of alternative approaches may be applied. According to one embodiment a plurality of communication devises may be searching for a communication device where each searching communication device is instructed to be searching, facing the device in a certain direction in relation to the direction of the one or more other searching communication devices, thereby together covering a larger geographical area, so that a certain geographical area may be searched both faster and more efficiently.

According to another embodiment the communication device to be detected may be assisted by one or more other communication devices in emitting a pattern in a controlled manner. A plurality of communication devices may be instructed to emit a pattern, using a specific pattern in relation to each other, e.g. based on input from an available positioning system, such as e.g. GPS. The cooperating communication devices may then emit a pattern in a synchronized manner so that e.g. all pattern emitting communication devices are either emitting a pattern at the same time, or they may be instructed to emit a certain pattern in relation to each other, so that the pattern emission is e.g. creating a running light effect, pointing or directing at the communication device to be detected.

A combination of different approaches may also be applied so that e.g. simultaneous emission is applied by all cooperating communication devices initially, whereas communication devices determined to be located most remote from the communication device 110b to be detected, gradually are terminating their pattern emission, in case one or more searching communication devices are approaching the communication device 110b to be detected.

Cooperative search of communication device, executed according to any of the suggested examples may be advantageous e.g. in a situation where a plurality of communication devices are used for detecting a missing person, where searching communication devices may be guided to search a geographical area, moving forward e.g. in a controlled straight line. Correspondingly, a communication device which is searched for may be assisted in pattern emission if emission is executed from a broadened geographical area in a controlled way.

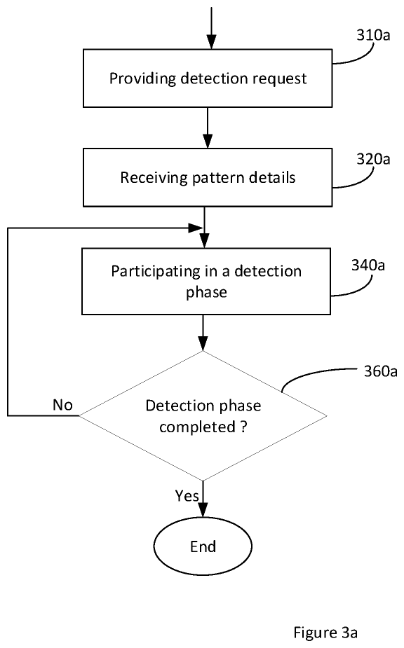

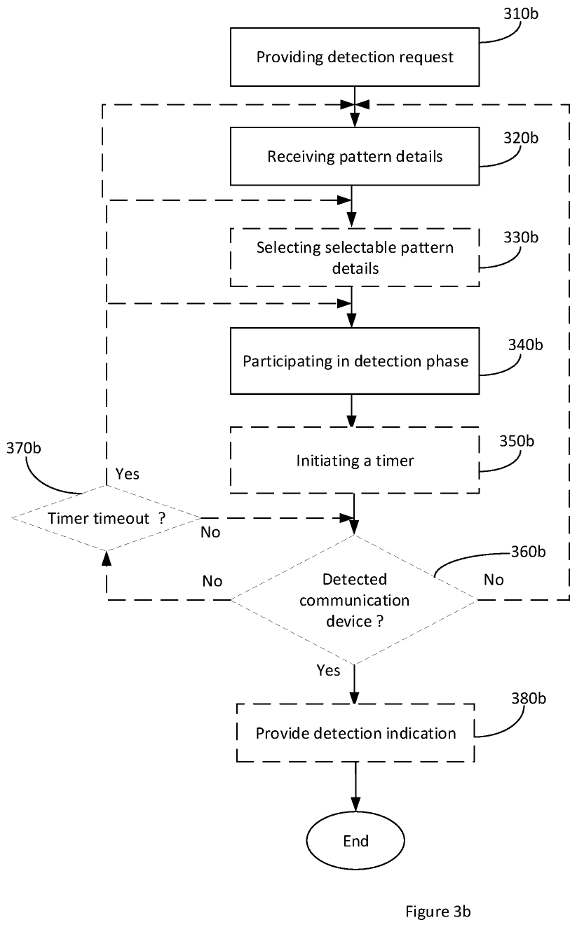

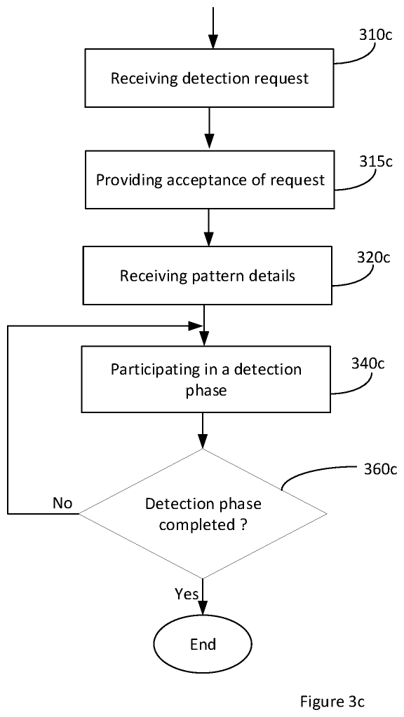

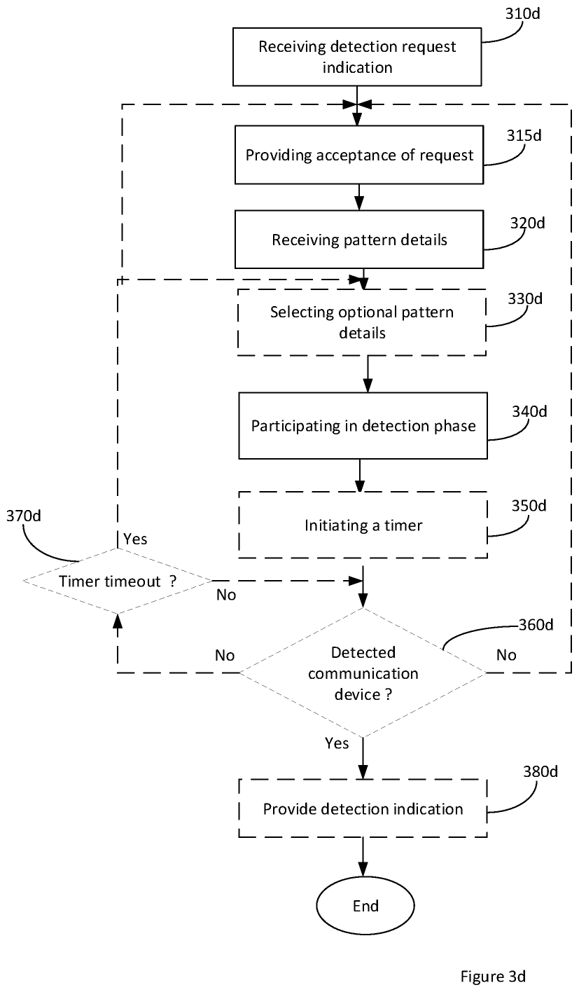

A method for communication device detection, requested by a communication device, here referred to as a first communication device, will now be described in further detail with reference to FIG. 3a, where, in a first step 310a, the first communication device requests a detection process to start from a detection function. As mentioned above, the request may be nothing more than just a request for the first and the second communication device to be able to detect each other, specified by the telephone number of the second communication device, or it may also comprise further details, relevant for the upcoming detection procedures, and available to the first communication device, such as e.g. known positioning information of the second communication device, roughly positioning that device. Alternatively, or in combination, the request may also comprise a permanent code to use for the upcoming detecting procedure, and/or personal information on the requesting user. As mentioned before, the request procedure may also comprise a negotiation, involving both communication devices, for the purpose of determining the role of each communication device in an upcoming detection procedure.

In a next step 320a the first communication device receives pattern details required for performing a detection procedure by the first communication device and at least a second communication device. This step can at the same time be seen as an acceptance of the request, by the second communication device. Alternatively, an acceptance of the request can be received by the first communication device in a separate message.

Once the details relevant for the requested detection procedure have been determined and provided to the first communication device, the first communication device can start to participate in the detection procedure, according to the acquired details, as indicated with another step 340a, if this is the task that has been appointed to the communication device by the detection function. As already mentioned herein, the participating may mean either emitting a pattern or searching for an emitted pattern. The detection procedure may continue until the initiated detection phase is completed, as indicated with step 360a, as detected automatically by the communication device, or this may be determined, after this has been manually indicated by the user of the first communication device.

As mentioned earlier, ending of the process may be postponed, in case the user of the first communication device prefers to be guided to the second communication device once the second communication device has been detected. In such a scenario, the process may instead be ended manually by the user of the first communication devices once the user verifies that the two users have not connected physically.

FIG. 3b is another flow chart of a method executed at a communication device, here referred to as a first communication device, which in more detail describes how a communication device, which is initiating a detection procedure, can execute a detection procedure. Steps 310b and 320b corresponds to step 310a and 320b, respectively. Optional step 330b illustrates how the first communication device selects selectable pattern details, i.e. selects at least some of the details on how to execute a detection procedure, rather than receive corresponding details, which have already been selected by the location function. Step 340b corresponds to step 340a of FIG. 3a, i.e. depending on which role the first communication will have in the detection process it will either emit a pattern or search for an emitted pattern according to acquired details on the pattern.

As indicated with optional step 350b, a timer may be started once a detection phase is started, in order to control the duration of the detection phase. Thereby, certain details may be applied during a detection phase, and, in case no communication device has been detected by another communication device, participating in the detection phase, upon time out of the timer, as indicated with the “No” branch to the left of step 360b and the “Yes” branch of step 370b, the method may continue according to one of a plurality of possible options. Although not shown in the figure, step 370b may also comprise informing the detection function of a timer time out, so that this function becomes aware of that new pattern details are to be provided, if applicable.

According to one option it may initiate a new detection phase with the same details, i.e. by continuing the method from step 340b. According to another option the first communication device may execute another detection phase after first having selected other selectable pattern details, i.e. by starting from step 330b. According to yet another option, new details may be received from the detection function before a new detection phase is started. If, on the other hand, no timer is applied, the method may instead be repeated, as indicated with the “No” branch of step 360b pointing to the right in the figure, until the user of the first communication device chooses to continue with the detection process. As indicated with optional step 380b, an indication that the first communication device has detected another communication device, participating in a detection process, can be transmitted to the detection function.

FIG. 3c is a flow chart illustrating a method, executed by a communication device, here referred to as a second communication device, where the communication device is not initiating any detection procedure, but is accepting to participate in a detection procedure, requested by another communication device, here a first communication device. In a first step 310c, the mentioned request is received from a detection function, and in a second step 315c, the second communication device accepts the request, i.e. to participate in a detection function, either as a pattern emitting device or as a pattern searching device, all according to what has been agreed upon in the request, possibly in combination with further, not shown, communication between the involved devices. Step 320c corresponds to step 320a and step 320b, whereas step 340c corresponds to step 340a. Step 360c corresponds to step 360a and 360b, whereas optional step 330d corresponds to step 330b.

FIG. 3d is describing a more detailed method, corresponding to the one described above, with reference to FIG. 3c, where the first step 310d corresponds to step 310c, whereas subsequent step 315d corresponds to step 315c. Step 320d corresponds to step 320 a, 320b and 320c. Optional step 330d is showing how optional pattern details may be selected by the communication device. Step 340d corresponds to step 340a, 340b and 340c, and step 340d corresponds to step 350d. Optional step 350d indicted that a timer is initiated, whereas optional step 360d corresponds to step 360a, 360b and 360c, step 370d corresponds to step 370b, and step 380d corresponds to step 380b.

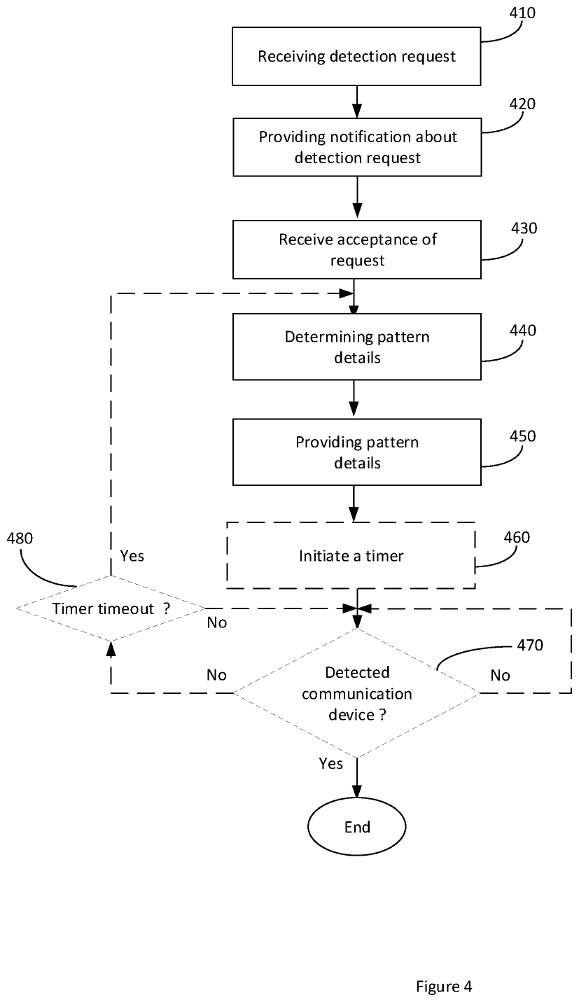

A method, executed at a function, herein referred to as a location function, for providing a possibility for a communication device, here referred to a first communication device, to request the two communication devices to locate each according to any of the methods described with reference to FIG. 3a, 3b or 3c. will now be described in further detail with reference to FIG. 4. In a first step 410, the detection function receives a detection request from a first communication device, and in a next step 420 a notification of the request is provided to a second communication device. Such a notification may in its simplest form be a notification of an identified communication device, wanting to locate another, identified second communication device, but such a notification may also comprise additional information, such as e.g. further instructions on the requested location process, as mentioned above.

In a next step 430 the detection function receives an acceptance of the request from the second communication device, and the detection process can thereby proceed, by the detection function determining pattern details, as indicated in step 440. Which pattern details that are to be provided to which communication device, i.e. which communication device that is to emit a pattern and which communication device that is to search for such an emitted pattern may be determined based on content of the request, on content of the acceptance of the request, or on any other type of data exchanged between one or both of the communication devices and the detection function, where such data may comprise e.g. one or more of capabilities data or user input.

In a subsequent step 450, the determined pattern details are provided to the respective communication devices, thereby preparing them for the upcoming detection process. Similar to the situation for the communication devices, also the detection function can apply a timer, for time limiting a selected approach, if required. Therefore, a timer may be initiated, as indicated in step 460.

If, in subsequent step 470, it is determined that no communication device has so far been detected, the location function may either, in case no timer is applied, continue to await information on detection, as indicated with the “No” branch to the right of FIG. 4, or, in case a timer is applied, continue to await detection, as long as the timer has not expired. Once it is determined that the timer has expired, according to the “Yes” branch of step 480, based on information received from one or both of the communication devices, the process may continue from the step of determining new light pattern details in step 440, or by starting a new timer with the already available details applicable for a new location process. Typically, a time out at step 480 will eventually, e.g. after a certain number of attempts or after a certain timer time intervals has elapsed, result in that the described method is terminated, resulting in a failed attempt for the communication devices to detect each other.

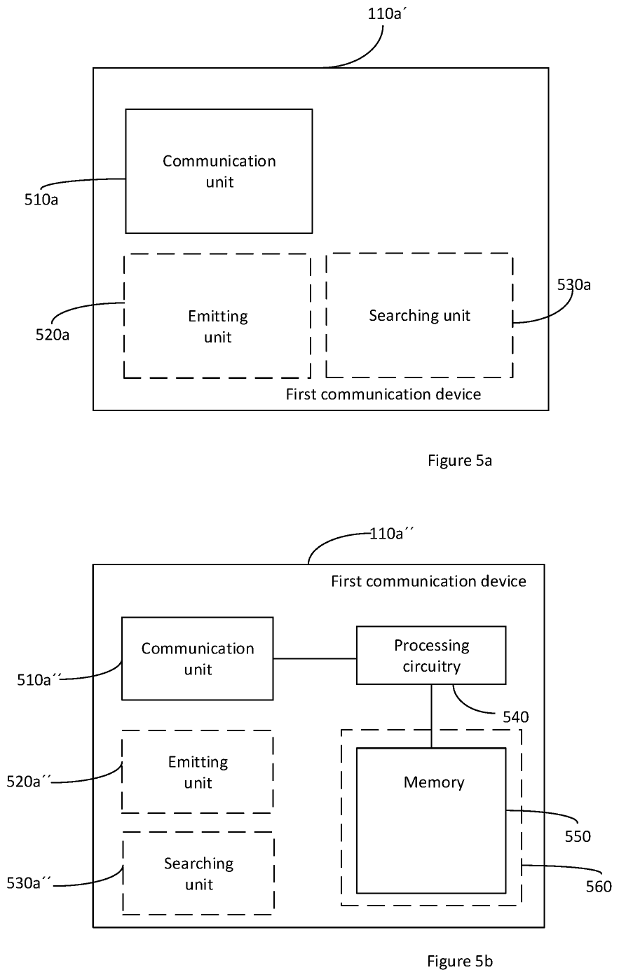

A communication device configured to execute a method according to any of the embodiments suggested above will now be described in further detail, with reference to FIG. 5a. The communication device, here referred to as a first communication device 110a′ is configured to engage in a communication device detection, or, in other words, to enable at least one of the first communication device 110a′ and a second communication device 110b to detect the other communication device. In this context, first communication device is to be referred to as a communication device which is requesting a detection function to be provided or executed, from a detection function.

The first communication device 110a′ is configured to provide a request, to a detection function 130, requesting one of the communication devices 110a′, 110b to detect the other during a detection phase, where the request is provided or transmitted to the detection function 130 via a communication unit 610a′. The first communication device 110a′ is also configured to receive details on an emitted pattern to be applied by the first communication device 110a during the detection phase, from the location function 130. The communication device 110a′ is then configured to participate in the detection phase, by applying at least parts of the received details for emitting a pattern, or by searching for the emitted pattern, by applying a searching unit 530a′. While a typical communication device, configured to participate in a detection phase, as described herein, comprise both an emitting device 520a′ and a searching unit 530a′, the first communication device 110a′ may, according to one alternative embodiment only comprise one of them. In the latter situation, it is a requirement for enabling a location procedure that the second communication device 110b comprise the other unit type, so that one of the communication devices will be able to emit a light pattern, whereas the other device will be able to search for the same light pattern.

According to another aspect, described with reference to FIG. 5b, a first communication device 110a″ comprises processing circuitry 540″, and a memory 550″, where the memory 550″ comprises computer readable instructions 560″, which when executed by the processing circuitry 540″, causes the first communication device 110a″ to request for and execute a detection method, as described herein. Also first communication device 110a″ comprise one or both of an emitting unit 520a″ and a searching unit 530a″, so that it can either emit a pattern, such as e.g. a light pattern or a sound pattern, or search for an emitted pattern, or execute both processes.

The memory 550″ can be any combination of random access memory (RAM) and/or read only memory (ROM). The memory 550″ also typically comprises persistent storage, which, for example, can be any single one or combination of magnetic memory, optical memory, solid-state memory or even remotely mounted memory. The processing circuitry 540″ may comprise e.g. one or more central processing unit (CPU), multiprocessor or digital signal processor (DSP).

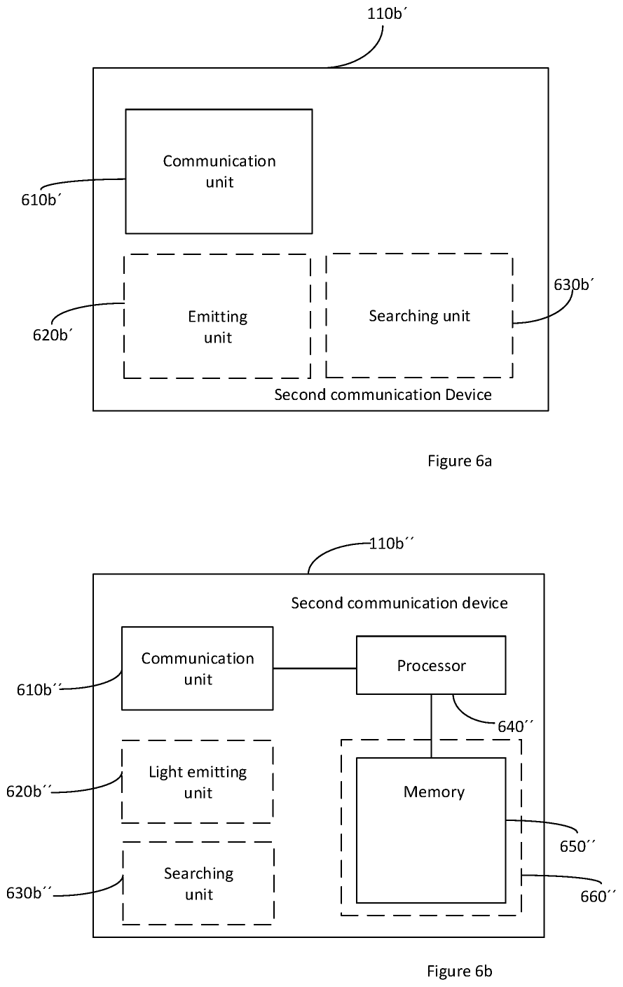

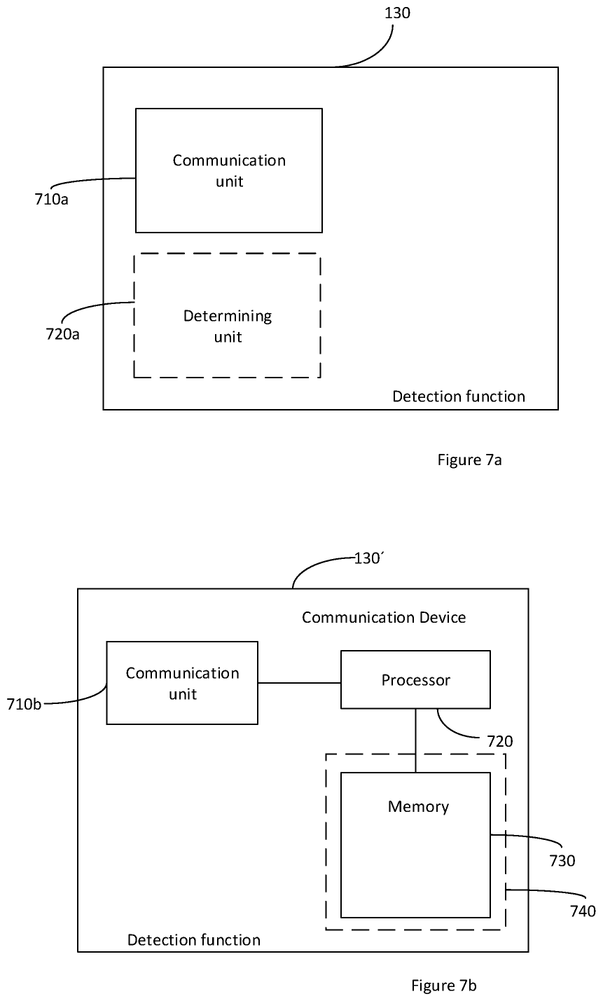

According to another aspect, a communication device, here referred to as a second communication device, capable of accepting a request for participation in a detection procedure, where the request has been initiated by another communication device, such as the communication device described above, with reference to FIG. 6a or 5b, is disclosed with reference to FIG. 6a.

The second communication device 110b′, 110b″ is configured to receive an indication from a detection function, where the indication is indicating that a first communication device 110a′, 110a″ has requested at least one of the first communication device 110a′, 110a″ and a second communication device 110b′, 110b″ to attempt to detect the other communication device (110a′, 110a″, 110b′, 110b″) during a detection phase. The second communication device 110b′, 110b″ is also configured to receive details on an emitted light pattern to be applied by the second communication device 110b′, 110b″ during the detection phase, from the detection function, upon having provided an acceptance of the request to the detection function, and to participate in the detection phase, by applying at least parts of the received details on the emitted light pattern.

According to yet another aspect, a communication device, here referred to as a second communication device, capable of accepting a request for participation in a detection procedure, where the request has been initiated by another communication device, is disclosed with reference to FIG. 6b. The second communication device 110b″ comprise processing circuitry 640″ and a memory 650″, where the memory 650″ comprises computer readable instructions 660″, which when executed by the processing circuitry 640″, causes the second communication device 110b″ to participate in and execute a detection method, as described herein. Also the second communication device 110b″ comprise one or both of an emitting unit 620a″ and a searching unit 630a″, so that it can either emit a pattern, such as e.g. a light pattern or a sound pattern, or search for an emitted pattern, or execute both processes.

The memory 650″ can be any combination of random access memory (RAM) and/or read only memory (ROM). The memory 650″ also typically comprises persistent storage, which, for example, can be any single one or combination of magnetic memory, optical memory, solid-state memory or even remotely mounted memory. The processing circuitry 640″ may comprise e.g. one or more central processing unit (CPU), multiprocessor or digital signal processor (DSP).

1. A method at a first communication device for engaging in a communication device detection process, the method comprising:
providing, to a detection function, a request for at least one of the first communication device and a second communication device to attempt to detect the other communication device during a detection phase;
receiving, from the detection function, details on an emitted light pattern to be applied by the first communication device during the detection phase, and
participating in the detection phase, based on at least parts of the received details on an emitted light pattern.

2. A method at a second communication device for engaging in communication device detection process, the method comprising:
receiving, from a detection function, an indication that a first communication device has requested at least one of a first communication device and the second communication device to attempt to detect the other communication device during a detection phase;
receiving, from the detection function, details on an emitted light pattern to be applied by the second communication device during the detection phase, upon having provided an acceptance of the request to the detection function, and
participating in the detection phase, by applying at least parts of the received details on the emitted light pattern.

3.-16. (canceled)

17. A method, at a detection function, for providing a communication device detection procedure to at least two communication devices, the method comprising:
receiving a request from the first communication device requesting one of a first communication device and a second communication device to attempt to detect the other communication device;
determining details on a light pattern to be applied by the first communication device and the second communication device during a detection phase, upon having received an acceptance of the request from one of the communication devices, and
providing the determined details on the light pattern to the first and the second communication device.

18.-21. (canceled)

22. A first communication device for engaging in communication device detection process, the first communication device being configured to:
provide, to a detection function, a request for at least one of the first communication device and a second communication device to attempt to detect the other communication device during a detection phase;
receive, from the detection function, details on an emitted light pattern to be applied by the first communication device during the detection phase, and
participate in the detection phase, based on at least parts of the received details on an emitted light pattern.

23. A second communication device for engaging in a communication device detection process, the second communication device being configured to:
receive, from a detection function, an indication that a first communication device has requested at least one of a first communication device and the second communication device to attempt to detect the other communication device during a detection phase;
receive, from the detection function, details on an emitted light pattern to be applied by the second communication device during the detection phase, upon having provided an acceptance of the request to the detection function, and
participate in the detection phase, by applying at least parts of the received details on the emitted light pattern.

24. The first or second communication device according to claim 1, configured to participate in the detection phase, by applying at least parts of the received details on the emitted light pattern, by:
emitting a light pattern according to at least parts of said details on an emitted light pattern, or
searching for the emitted light pattern according to at least parts of said details on an emitted light pattern.

25. The first or second communication device according to claim 24, wherein the request comprises information decisive on which of the communication devices that shall emit light and which communication device that shall search for the emitted light.

26. (canceled)

27. The first or second communication device according to claim 22, wherein said communication device is configured to handle details on an emitted light pattern which comprise at least one of:
a searching procedure to be applied during a detection phase;
at least one direction in which to arrange at least one light pattern sensing device during a detection phase;
at least one orientation in which to arrange at least one light pattern sensing device during a detection phase;
at least one sequence in which to sweep at least one light pattern sensing device during a detection phase;
details on how to activate at least one light pattern sensing device during a detection phase, and
details on when in time in a detection phase to apply a light pattern sensing device, during a detection phase.

28. The first or second communication device according to claim 22, wherein said communication device is configured to handle details on an emitted light pattern which comprise at least one of:
a light emitting procedure to be applied during a detection phase;
at least one direction in which to arrange at least one light pattern searching device during a detection phase;
at least one orientation in which to arrange at least one light pattern searching device during a detection phase;
at least one sequence in which to sweep at least one light pattern searching device during a detection phase;
details on at least one light strength to apply by at least one emitting light source during a detection phase;
details on at least one frequency to apply by at least one emitting light source during a detection phase;
details on how to activate at least one light pattern searching device during a detection phase, and
details on when in time in a detection phase to apply a light pattern searching device, during a detection phase.

29. The first or second communication device according to claim 22, configured to determine at least some emitting light pattern details and of transmitting the determined details to the other communication device.

30. The first or second communication device according to claim 22, further configured to:
receive, from the detection function, updated details on an emitted light pattern to be applied by the receiving communication device during an upcoming detection phase, and
participate in the upcoming detection phase, by applying at least parts of the received, updated details on the emitted light pattern.

31. The first or second communication device according to claim 22, configured to participate in the detection phase by applying at least parts of the emitted light pattern details by searching for emitted light with at least one light sensing device.

32. (canceled)

33. The first or second communication device according to claim 22, configured to participate in the detection phase by applying at least parts of the emitted light pattern details by emitting light with at least one light emitting device.

34. (canceled)

35. The first or second communication device according to claim 22, further configured to exchange capabilities, relevant for executing a detection attempt during a detection phase.

36. The first or second communication device according to claim 22, further configured to notify the detection function that the communication device is about to terminate an ongoing detection attempt.

37. (canceled)

38. A detection function, for providing a communication device detection procedure to at least two communication devices the detection function being configured to:
receive a request from the first communication device requesting one of a first communication device and a second communication device to attempt to detect the other communication device;
determine details on a light pattern to be applied by the first communication device and the second communication device during a detection phase, upon having received an acceptance of the request from one of the communication devices, and
provide the determined details on the light pattern to the first and the second communication device.

39. The detection function according to claim 38, further configured to manage exchange of capabilities, relevant for execution of a detection phase, between the first communication device and the second communication device.

40. The detection function according to claim 38, configured to provide details on an emitted light pattern comprising at least one of:
a searching procedure to be applied during a detection phase;
at least one direction in which to arrange at least one light pattern sensing device during a detection phase;
at least one orientation in which to arrange at least one light pattern sensing device during a detection phase;
at least one sequence in which to sweep at least one light pattern sensing device during a detection phase;
details on how to activate at least one light pattern sensing device during a detection phase;
details on when in time in a detection phase to apply a light pattern sensing device, during a detection phase;
a light emitting procedure to be applied during a detection phase;
at least one direction in which to arrange at least one light pattern searching device during a detection phase;
at least one orientation in which to arrange at least one light pattern searching device during a detection phase;
at least one sequence in which to sweep at least one light pattern searching device during a detection phase;
details on at least one light strength to apply by at least one emitting light source during a detection phase;
details on at least one frequency to apply by at least one emitting light source during a detection phase;
details on how to activate at least one light pattern searching device during a detection phase, and
details on when in time in a detection phase to apply a light pattern searching device, during a detection phase.

41. The detection function according to claim 38, further configured to:
determine that a third communication device is suitable for participating in the requested detection attempt, and
repeat said steps for the third communication device.

42. The detection function according to claim 38, configured to provide details on a light pattern which are determined based on at least:
the communication devices capable of participating in the detection attempt;
light conditions in the environment of at least one of the communication devices capable of participating in the detection attempt;
mobility of the communication devices capable of participating in the detection attempt;
capabilities of the communication devices capable of participating in the detection attempt.
